(19) United States
(12) Patent Application Publication
(10) Pub. No.: US 2007/0214408 A1
(43) Pub. Date: Sep. 13, 2007

(54) DECLARATIVE WEB APPLICATION FOR SEARCH AND RETRIEVAL

(75) Inventors: Roland U. Straub, Zug (CH); James R. Hamill, Fort Collins, CO (US)

Correspondence Address: COCHRAN FREUND & YOUNG LLC, 2026 CARIBOU DR, SUITE 201, FORT COLLINS, CO, 80525, US

(73) Assignee: OPTIMUS CORPORATION, Fort Collins, CO (US)

(21) Appl. No.: 11/683,009

(22) Filed: Mar. 7, 2007

Related U.S. Application Data
(60) Provisional application No. 60/780,128, filed on Mar. 7, 2006.

(51) Int. Cl. G06F 17/00; G06F 7/00; G06F 17/30

(52) U.S. Cl. 715/513; 715/530; 707/1

(57) ABSTRACT

Disclosed is a method and Declarative Web Application (DWA) for creating an abstraction layer between a web page and the complicated syntax required to access data to display on the web page. The abstraction layer is implemented with eXtensible Markup Language (XML) tags that permit a web page using simple, non-compiled custom XML tags embedded in Hyper Text Markup Language (HTML) formatting commands to call complex data storage and search engine queries using a simple, declaratory statement via a XML tag. Use of the simple, declaratory XML statement removes the need for any scripting or other complex code from the web page that may require compilation and/or extensive verification testing for changes to the web page code. The resulting web pages and query definitions are easier and less expensive to maintain and extend. Further, the data returned from the data storage system is formatted to be name and content addressable such that the HTML commands to display the data are implemented using a simple, declarative syntax of XML tags. Again, the use of simple, declarative XML tags allows the web page code to be restricted to simple HTML code, thus, avoiding the need to compile and/or perform extensive verification testing when a change is made to the HTML code. The system deskills the expertise necessary to create a data rich web page such that a graphic web designer is capable of creating a web page without the assistance of a Java or Structured Query Language (SQL) programmer. Also, the SQL programmer may create and then make queries available without the assistance of a programmer and without the need to use a programming language other than SQL.

### CROSS REFERENCE TO RELATED APPLICATIONS

This application is based upon and claims priority to U.S. provisional application Ser. No. 60/780,128, filed Mar. 7, 2006, by Roland U. Straub and James R. Hamill, entitled “Declarative Web Application for Search and Retrieval,” which is specifically incorporated by reference herein for all that it discloses and teaches.

### BACKGROUND OF THE INVENTION

There have been a large number of technologies and approaches for developing application frameworks around the Internet and the World Wide Web. By far the most common frameworks depend on “server pages” technology. Server pages technology typically involves a mixture of standard Hyper Text Markup Language (HTML) and some sort of scripting language used for the dynamic creation of some portion of the Hyper Text Markup Language (HTML) web pages. The server page languages are all very similar, differing only in the syntax for a particular programming language or framework. Examples of different programming frameworks include: Java Server Pages (JSP), Active Server Pages (ASP), ASP.NET, Hypertext Preprocessor (PHP), etc. The programming frameworks act as programming language hybrids and are designed to make it easy for programmers to develop dynamic web pages that may act as part of an application, including implementation of business logic and interaction with databases.

The programming languages and frameworks typically allow a programmer to embed business logic and practically any programming language construct in the web pages that the framework or programming language support. In some cases (e.g., Java 2 Enterprise Edition—J2EE—JSP), the programming frameworks dynamically generate a source code page in a given language (e.g., Java) and compile a new dynamically loaded object module or library (e.g., *.class file), which executes in a virtual machine environment and creates the page. For a business to maintain a workforce proficient in with the programming frameworks, the business must pay for programming skills above and beyond a typical HTML developer or web page graphics designer. Simple changes may require advanced programming skill since the dynamic generation of content is written in the programming language of the framework. Often an expensive and lengthy certification process is employed to ensure that an application satisfies security concerns such as protection against viruses and abuse over a network. In general, the user interface employs a web browser and submits an HTTP get/up request to the server which in turn executes server side server page code to perform the user requested function. The server pages may execute within a network or on a standalone, disconnected system.

### SUMMARY OF THE INVENTION

An embodiment of the present invention may comprise a method of writing and processing an HTML web page comprising: embedding declarative XML tags within HTML code defining the HTML web page in place of complex data request commands and complex data formatting commands; converting the declarative XML tags into the complex data request commands for a computer readable data storage system; sending the complex data request commands to the computer readable data storage system; receiving raw data from the computer readable data storage system in response to the complex data request commands; converting the raw data into a dynamic web page based on the declarative XML tags contained within the HTML code; and delivering the dynamic web page.

An embodiment of the present invention may further comprise a declarative web application abstraction layer running on a computer system for processing an HTML web page comprising: an HTML web page input for receiving the HTML web page from a web browser application, the HTML web page defined by HTML code containing embedded declarative XML tags in place of complex data request commands and complex data formatting commands; a data request command output for sending the complex data request commands to a computer readable data storage system; a raw data input for receiving raw data from the computer readable data storage system in response to the complex data request commands; a dynamic web page output for delivering a dynamic web page to the web browser application; a DWA query generation engine that converts the declarative XML tags contained in the HTML web page received by the HTML web page input into the complex data request commands and that further sends the complex data request commands to the computer readable storage system via the data request command output; and a DWA result formatting engine that converts the raw data received by the raw data input in response to the complex data request commands sent to the computer readable storage system into the dynamic web page based on the declarative XML tags contained within the HTML code and that further sends the dynamic web page to the web browser via the dynamic web page output.

An embodiment of the present invention may further comprise a declarative web application abstraction layer running on a computer system for processing an HTML web page comprising: means for obtaining an HTML web page defined by HTML code with embedded declarative XML tags in place of complex data request commands and complex data formatting commands; means for converting the declarative XML tags into the complex data request commands; means for sending the complex data request commands to a computer readable data storage system; means for receiving raw data from the computer readable data storage system in response to the complex data request commands; means for converting the raw data into a dynamic web page based on the declarative XML tags contained within the HTML code; and means for delivering the dynamic web page.

### BRIEF DESCRIPTION OF THE DRAWINGS

In the drawings,

FIG. 1 is a schematic illustration of the system architecture for a Declarative Web Application (DWA) embodiment.

FIG. 2 is an illustration of screen 1 of a search process and the associated Hyper Text Markup Language (HTML) code that is sent to an embodiment.

FIG. 3 is an illustration of screen 2 and the associated HTML code that is sent to an embodiment for the search process of FIG. 2.

FIG. 4 is an illustration of screen 3 and the associated HTML code that is sent to an embodiment for the search process of FIGS. 2 and 3.

FIG. 5 is a schematic illustration of the DWA query and filter tag architecture for an embodiment.

FIG. 6 is a schematic illustration of the DWA result set tag architecture for an embodiment.

FIG. 7 is a HTML code snippet illustrating the HTML code used to implement the query, filter, and result set tag architecture described in FIGS. 5 and 6 for an embodiment.

### DETAILED DESCRIPTION OF THE INVENTION

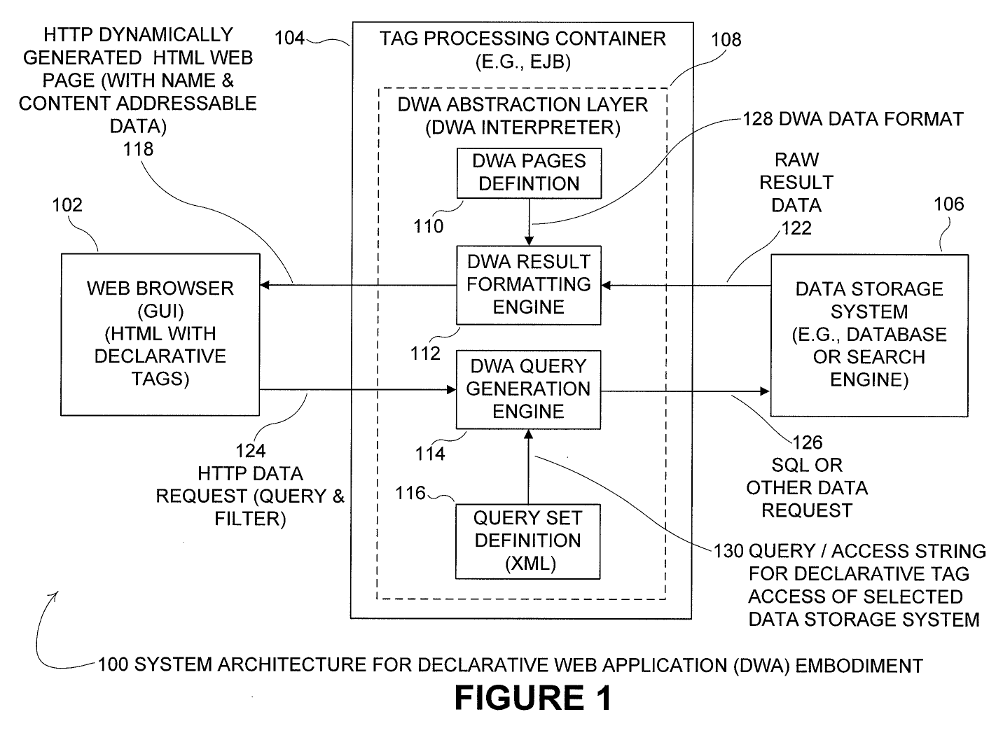

FIG. 1 is a schematic illustration of the system architecture 100 for a Declarative Web Application (DWA) embodiment. A web browser 102 functions as the Graphical User Interface (GUI) to display data to a user. The web browser 102 opens a web page desired by a user. The web page is written such that the Hyper Text Markup Language (HTML) commands of the web page contain declarative eXtensible Markup Language (XML) tags to define the data to display on the web browser 102. The declarative XML tags are also known as Declarative Web Application tags. The declarative XML tags are simple, declaratory statements of the data needed for display on the web browser 102. The declarative XML tags do not include the specific syntax and formatting necessary to request and retrieve data from the data storage system 106.

Based on the declarative XML tags, the web browser 102 sends HTTP requests 120, 124 to a tag processing container 104. The tag processing container 104 may be provided by any tag processing container technology. The tag processing container 104 shown in FIG. 1 utilizes Enterprise Java Beans (EJB) technology. For an embodiment, a DWA abstraction layer 108, also known as the DWA Interpreter 108, is implemented within the tag processing container 104. The HTTP requests 124 containing the query and filter are handled by the DWA abstraction layer 108. The DWA query generation engine 114, a part of the abstraction layer 108, accepts the HTTP requests for query and filter 124 the declarative XML tag information from the web browser 102. The DWA query generation engine 114 then retrieves the correct query or data access syntax 130 for the desired data storage system 106 from the query set definition 116. The query set definition 116 contains a list of the possible declarative XML tags and the corresponding query and/or data access syntax necessary to retrieve the requested data from the data storage system 106. Some of the declarative XML tags in the HTML code are filter tags used to designate data filters to apply to the data requested from the data storage system 106. The DWA query generation engine 114 creates a query and/or data request 126 for the data storage system 106 based on the data access formats associated with a particular declarative XML tag in the query set definition 116 and any declarative filter tags contained in the HTML code of the web page. Possible basic query types stored in the query set definition 116 include, but are not limited to: term query (i.e., a keyword or key field search), Boolean query, phrase query, prefix query, phrase prefix query, range query, filtered query, span query, and fuzzy query. The resulting data storage query 126 may be a Structured Query Language (SQL) query or some other appropriate form for a search engine. Either form may be considered as an example of a data access request, the DWA query generation engine 114 sends the SQL or other data request 126 to the data storage system 106. After creating the data access request, the DWA query generation engine 114, sends the SQL or other data request 126 to the data storage system 106. The data storage system 106 may be a relational database, a compressed database (e.g., a database stored on a CD or other size restricted computer storage medium), object oriented database, flat file database, other type of database, a remotely accessible search engine, or any other data storage system. The SQL or other data request 126 may be any textual or non-textual command syntax necessary to communicate a data request to a data storage system 106.

Based on the SQL or other data request 126 sent by the DWA query generation engine 114, the data storage system 106 retrieves the desired data 122 from storage. The desired data 122 is sent to the DWA result formatting engine 112 of the DWA abstraction layer 108 in the raw format of the data storage system 106. The DWA result formatting engine 112 formats the raw result data 122 by making the data name and content addressable. The DWA result formatting engine 112 formats the data based on a DWA format 128 obtained from the DWA pages definition 110 list of formats. The DWA pages definition 110 list of possible DWA formats associates the declarative XML tag with a particular DWA data format. The declarative XML tags for a particular transaction are obtained from the formatting HTTP requests 120 sent by the web browser 102 at the same time the data query HTTP requests 124 were sent to the DWA query generation engine 114. Once the DWA result formatting engine 112 has interpreted the raw result data 122 based on the HTTP format requests 120 and the associated DWA data format 128, the DWA result formatting engine creates an dynamic HTML web page 118, which is then passed to the web browser 102 for display.

By requiring only simple, declarative XML tags to define the data and associated filters for a HTML document loaded into a web browser 102, the web page designer is relieved from the need to be capable of writing the complex SQL queries or other data access commands 126 that retrieve data from the data storage system 106. The sophisticated programming skill necessary to access the data storage system 106 is abstracted into the query set definition 116 and the DWA query generation engine 114 by expert data access programmers (e.g., SQL programmers). Thus, the creation and maintenance of the web page code is deskilled to only the knowledge necessary to create the HTML commands to display the data and not the additional skill necessary to actually access the data storage device 106. Similarly, by making the raw result data 122 name and content addressable data in a dynamic HTML web page 118, the web page designer is relieved from the need to have any specific knowledge of the format and syntax of the raw result data 122 delivered by the data storage system 106.

Since the web page HTML code of a page loaded onto the web browser 102 written by the web designer does not need to contain the complex scripting and coding necessary to access the data storage system, the web page does not need to be compiled and/or be extensively verification tested in the same manner as a heavily scripted page such as a Java Server Page (JSP) may need to be tested. Further, the system does not need to automatically create higher level complex scripts or code in response to the declarative XML tags that would need to be compiled and/or extensively tested each time the HTML code is updated. Also, since the generalized search and retrieval capabilities are coded in a generalized form designed for use in a declarative fashion, the supporting code should not need to be modified and/or tested as often. Since the HTML and XML are not compiled, there is a default mind set that the web page does not need to be tested as extensively as a compiled web page or the supporting code of the web page. The default mind set is due to the fact that with uncompiled code (also known as clear text code), it is generally more difficult to hide computer viruses or of improperly accessing secure data storage systems. Thus, updates to the web page user interface may be performed with minimal testing while changes to the data abstraction layer may be tested more thoroughly. The separation of testing of the user interface HTML code loaded onto the web browser 102 and the data retrieval abstraction layer 108 permits quick updates and changes to the user interface HTML code on the web browser 102 while maintaining the data access accuracy and security testing necessary for the data retrieval commands 126 sent by the data abstraction layer 108.

Further, the query set definition 116 may be changed to match any number of possible data storage systems 106. Thus, the same HTML web pages loaded onto the web browser 102 used to access data for one data storage system 106 may be used to access a different data storage system 106 without making any changes to the HTML code. The query set definition 116 is updated to properly access the desired data storage system 106. Therefore, the same user interface pages may be used to access a database over the Internet when interacting with a full scale relational database and when accessing a compressed database stored on a compact disc. Similarly, the formatting of the data into name and content addressable data on a dynamic HTML page 118 utilizes a list of formats in the DWA pages definition 110. Thus, the formatting associated with a declarative XML formatting tag may be changed at one location, the DWA pages definition 110, without updating every web page that uses the declarative formatting XML tag.

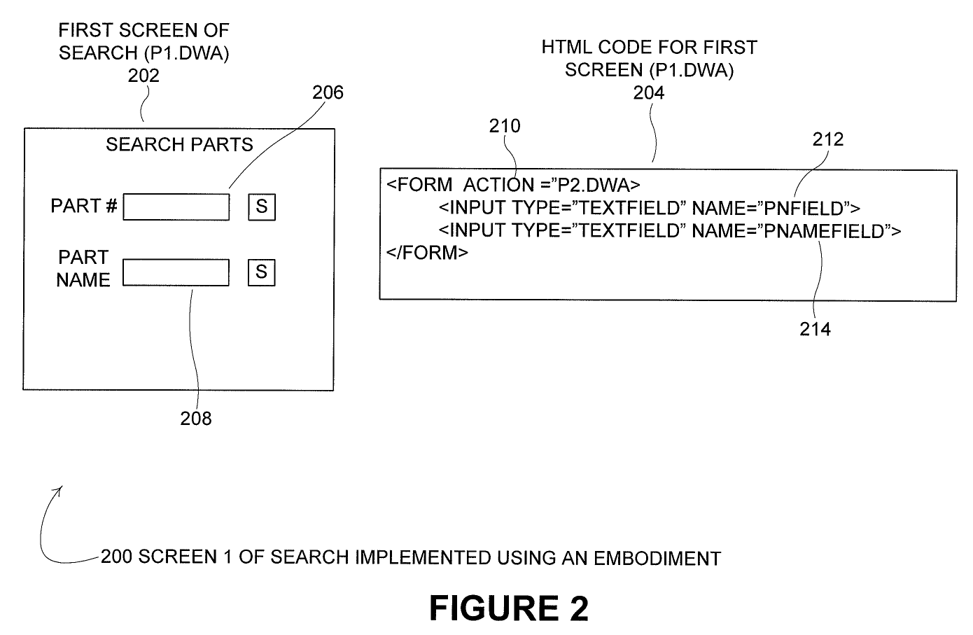

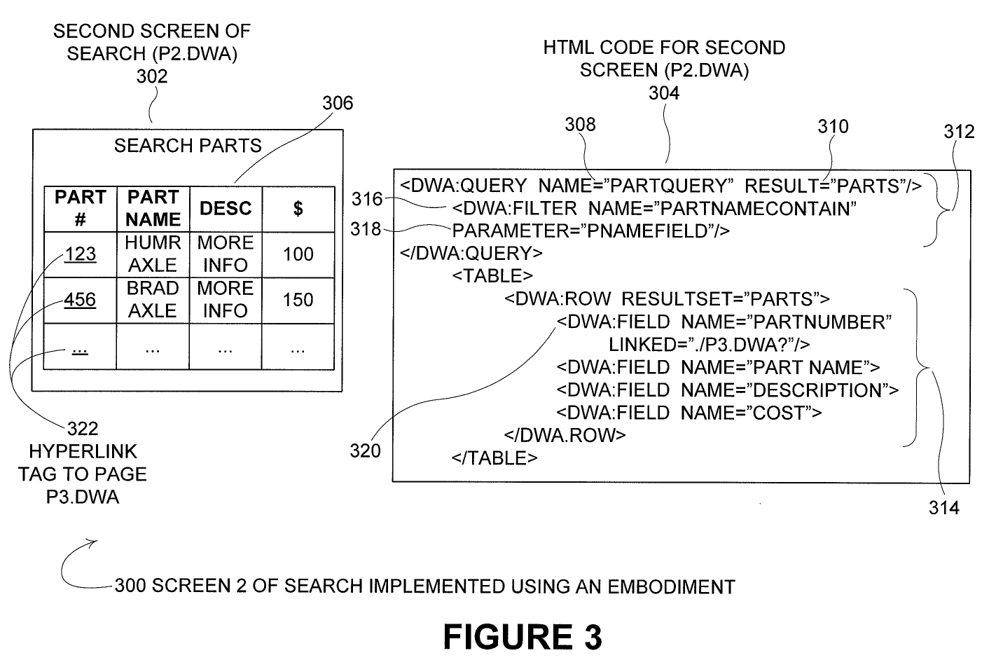

FIG. 2 is an illustration 200 of screen 1 (202) of a search process and the associated HTML code 204 that is sent to an embodiment. The screen 202, named P1.DWA, contains text entry fields 206, 208 for entering the part number 206 and the part name 208. The HTML code for the first screen 204 indicates that the screen will link to the second screen, P2.DWA on the first line 210. The input for part number 206 is saved to a text field named “PNFIELD” 212 within the HTML code 204. The input for part name 208 is saved to a text field named “PNAMEFIELD” 214 within the HTML code 204. The fields created and filled in by this page, P1.DWA, become parameters in the Hyper Text Transfer Protocol (HTTP) request for page P2.DWA, which is disclosed in the description with respect to FIG. 3.

FIG. 3 is an illustration 300 of screen 2 (302) and the associated HTML code 304 that is sent to an embodiment for the search process of FIG. 2. The second screen 302, named P2.DWA, displays the data results 306 of the data request sent to the abstraction layer of an embodiment. The HTML code 304 for the second screen 302 begins with a declarative call to the DWA query 312. The declarative DWA query 312 is made up of the declarative name of the query 308, the name of the result set 310 to place the resulting data, the name of a filter 316 to filter the query 312, and the parameter data 318 from the HTTP request to use as the filter. The data queried for screen 2 (302) is a part query 308 that places query results in the “PARTS” result set 310, and filters the data to only the data where the part name contains 316 the value of the part name field 318 from screen 1 (202), as screen 1 (202) was disclosed with respect to the description of FIG. 2.

The data table 306 of screen 2 (302) is filled with the results in the “PARTS” result set 310 using table and associated row functionality 314 to display the data. Each field name 314 of the “PARTS” data 310 are data fields defined by the part query 308 in the query set definition. It is also possible to link 320, 322 a cell in the table 306 to another screen. In the screen 2 (302) shown in FIG. 3, the table 306 contains rows of data, with each row containing the data specified in the fields 314 of the “PARTS” 310 data. Here, the fields 314 are part number 322, part name, description, and cost. The part number field 320, 322 is designated to link to a third screen, named P3.DWA, to show the details for the part number in the selected row of the table 306.

Using an embodiment, the data retrieval statements 312, 314 in the HTML code 304 are simple declarations. The declarations 312, 314 do not require the web page developer to actually create a SQL statement. The web page developer simply provides a top level declaration of the data needed for display on the screen 302. Thus, the complexity of the HTML code 304 is significantly reduced and the HTML code does not contain any scripting or coding that may require compiling and/or extensive verification testing. Therefore, simple modifications (e.g., adding tables adding fields, changing attributes of the data, etc.) are achieved more easily.

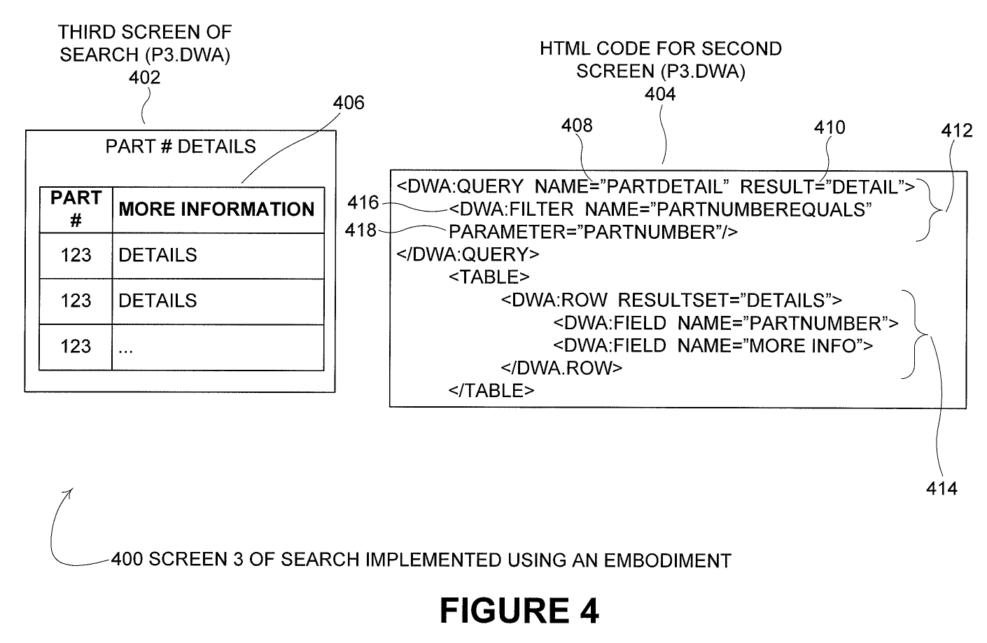

FIG. 4 is an illustration 400 of screen 3 (402) and the associated HTML code 404 that is sent to an embodiment for the search process of FIGS. 2 and 3. The third screen 402, named P3.DWA, shows the details for a specific part number in a table 406. Each row of the table 406 has the same part number plus some additional detail information about the part. The HTML code 404 to implement the third screen 402 starts with a declarative query statement 412. The declarative query statement 412 is made up of the name of the query 408, the name of the result set 410 to place the resulting data, the name of a filter 416 to limit the query 412 results, and the parameter data 418 to use as the filter. The data queried for screen 3 (402) is a part detail query 408 that places query results in “details” 410, and filters the data to only the data where the part number equals 416 the part number 418 value.

The data table 406 of screen 3 (402) is filled with the result “details” data 410 using table and associated row functionality 414. Each field name 414 of the “details” data 410 are data fields defined by the part detail query 408 in the query set definition. In the screen 3 (402) shown in FIG. 4, the table 406 contains rows of data, each row containing the data specified in the fields 414 of the “details” data set 410. Here, the fields 414 are part number and more info.

All data retrieval statements 412, 414 in the HTML code 404 are simple declarations. The declarations 412, 414 do not require the web page developer to actually create a SQL statement. The web page developer simply provides a top level declaration of the data needed for display on the screen 402. Thus, the complexity of the HTML code 404 is significantly reduced and the HTML code does not contain any scripting or coding that may require compiling and/or extensive verification testing.

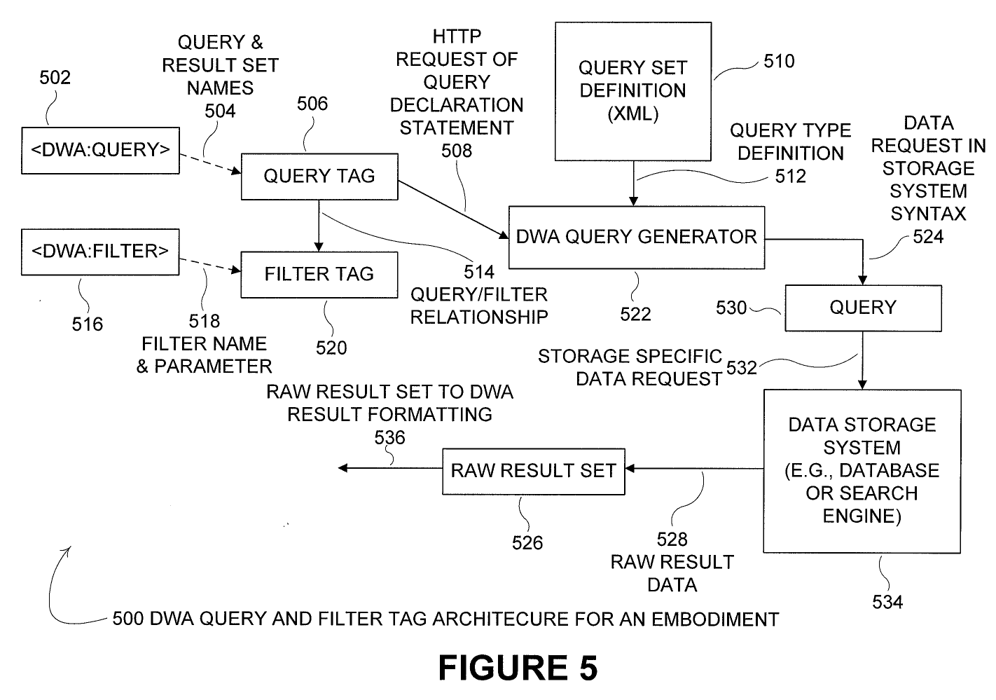

FIG. 5 is a schematic illustration of the DWA query and filter tag architecture 500 for an embodiment. The HTML declarative statement for the query 502 supplies the declarative name of the desired query and the name of the result set to hold the results returned by the query 504, thus defining the query tag 506. The HTML declarative statement for the filter 516 supplies the filter name and the data parameter 518, thus, defining the filter tag 520. The query tag 506 and the filter tag 520 are related 514 such that the query tag 506 and filter tag 520 define the HTTP request of the query declaration statement 508 sent to the DWA query generator 522. Given the HTTP query declaration request 508, the DWA query generator creates the actual query or other data request 524 to send to the data storage system 534.

The query set definition 510 supplies the query type definition 512 to the DWA query generator 522. The query definition type 512 defines the format for the data request in the syntax of the desired storage system 534. The query set definition 510 contains a list of possible queries correlated to a declarative XML query name. The DWA query generator 522 uses the query tag 506 to obtain the correlating query type definition 512 from the query set definition 510. Once the DWA query generator 522 has received the query type definition 512 from the query set definition 510, the DWA query generator 522 creates the storage data request 524 using the data in the query tag 506, the filter 520 tag, and the syntax in the query type definition 512. The data request formatted for the data storage system 534 is the query 530 that supplies the storage specific data request 532 to the data storage system 534. The raw result data 528 from the data storage system 534 is the result set 526. The raw result set is the data 536 that is formatted by the DWA result formatting engine such that the data is name and content addressable within a dynamic HTML web page.

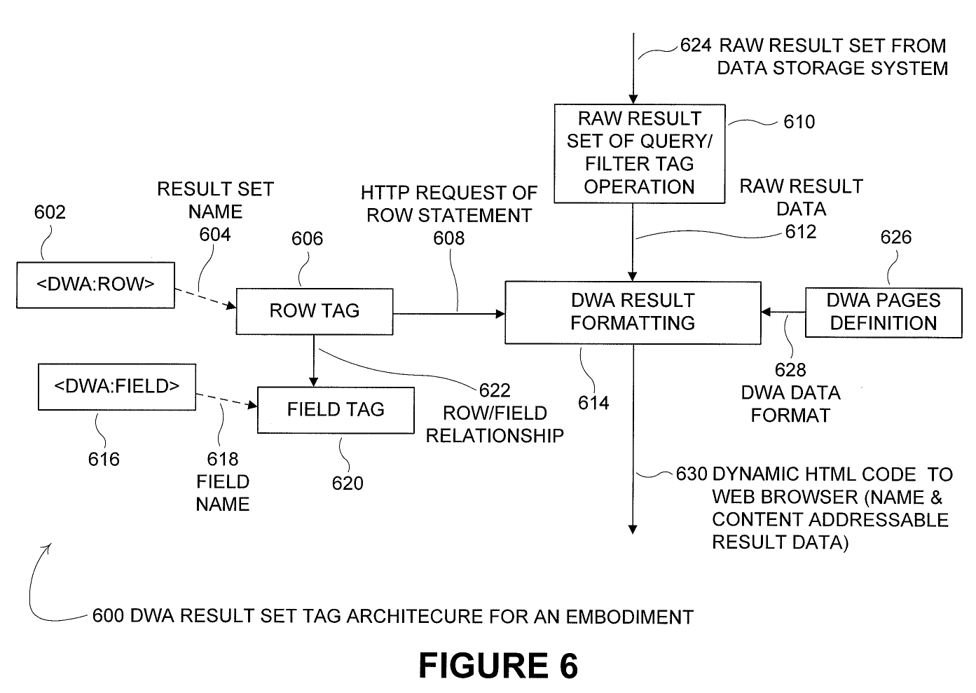

FIG. 6 is a schematic illustration of the DWA result set tag architecture 600 for an embodiment. The HTML declarative statement for the table row 602 supplies the name of the desired result set 604, thus defining the row tag 606. The HTML declarative statement for the field 616 supplies the field name 618 of the specific data to extract from the result set 610, thus defining the field tag 620. The row tag 606 and the field tag 620 are related 622 such that the row tag 606 and field tag 620 define the name and content addressable data 630 that DWA result formatting 614 supplies to the web browser using dynamic HTML web pages 620. DWA result formatting obtains raw result set data 624 from the result set 610 of the query operation performed on the data storage system as disclosed in the description with respect to FIG. 5. The raw result data 612 is formatted by DWA result formatting 614 based on the row tags 606 and field tags 620 sent via the HTTP request of the declarative row statement 608. DWA result formatting 614 corresponds the information in the HTTP row request 608 with a DWA data format 628 in the DWA pages definition 626 to create the final dynamic html page 630 to send to the web browser. The output 630 of the DWA row and DWA field tags from DWA result formatting 614 are standard HTML “<TR>” row tags and “<TD>” data cell tags containing the data values retrieved from the DWA result set.

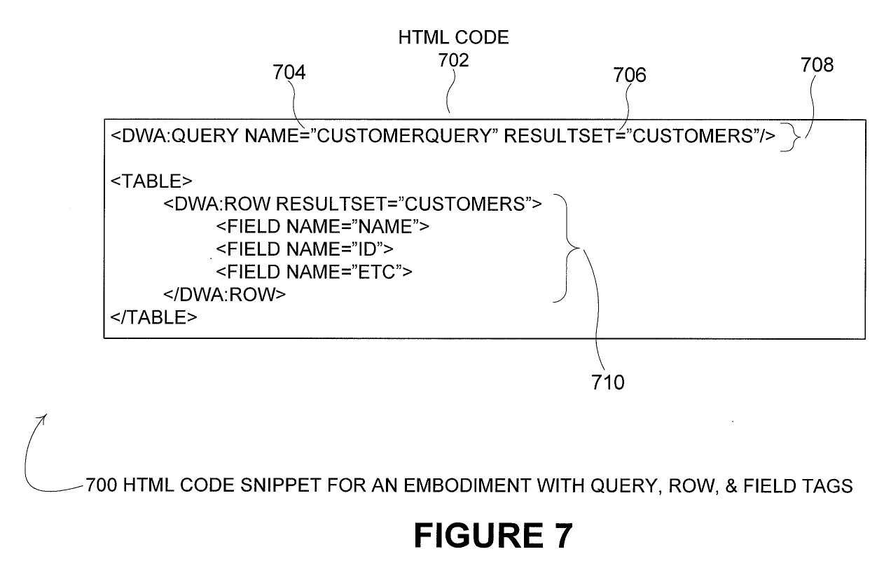

FIG. 7 is a HTML code snippet 700 illustrating the HTML code 702 used to implement the query, filter, and result set tag architecture as disclosed in the description with respect to FIGS. 5 and 6 for an embodiment. The declarative query tag 708 contains the declarative name 702 of the query and the name of the result set 706 to place the data found by the query operation. The row and field tags 710 define the data from the name and addressable result set 706 that will be displayed on the web page. As noted above, the HTML code is simple and does not require any knowledge of the specific syntax and/or logic necessary to obtain the result set 706 data.

An embodiment may involve the creation of a set of Declarative Web Application tags that abstract out all procedural language constructs such as abstracting of data query methods from display methods. The abstraction and separation of the query and the display of the data results returned from the query are achieved to such an extent that all changes (e.g., addition, modification, deletion, filtering, ranking, relevance, order, authorization, etc.) may simply be declared using Declarative Web Application tags in the HTML web pages and XML query set definitions maintained in a separate file. Thus, procedural programming power and its associated security risks are removed from the server pages framework because the embodiment provides a declarative syntax that merely specifies where and what to display.

The use of Declarative Web Application tags eliminates the requirement to utilize higher level programming skills for dynamic HTML. Several key and often competing concerns in the web application development are productivity, cost and security. The need to make changes and enhancements to any software application but particularly web applications is a constant concern. In a web application development environment these changes may, and often must, be made with turnaround times measured in days and weeks. When the changes involve the use of highly skilled software development personnel, the cost is proportionally higher. Also, the potential for bugs and security leaks are also increased with the modification of code.

An embodiment may also involve the creation of a portable server page execution framework, known as the Declarative Web Application Interpreter, that can execute in a standard Java 2 Enterprise Edition (J2EE) container, interpreting Declarative Web Application tags to produce dynamic HTML will not require re-certification when changes are made to the Declarative Web Application pages. The fact that system and network security may be compromised by crashing a web application means that it is imperative that code changes receive rigorous testing and certification to ensure security is not compromised. The additional testing and certification further increases costs and delays release of changes to the product. Changes to a J2EE JSP web page require a compilation of the web page, which is considered by some software and security personnel a substantial change in the web page since it results in a modified bytecode file (*.class file). A *.class file is essentially an executable binary to the J2EE Java Runtime Environment or Java Virtual Machine (JVM). Changes to binary executables that are downloaded onto a system without going through a security certification process may be deemed an unacceptable security risk.

An embodiment may also involve the creation of a set of DWA tag translation libraries that accept and translate the Declarative Web Application tags and that execute in a standard J2EE environment. The tag libraries produce the same results as the Declarative Web Application Interpreter. The tag libraries dynamically would still generate Java source code and compile it, as is true for all standard J2EE JSP containers. Thus, code may be written on a standard J2EE application server, but still allow the Declarative Web Application pages to be directly ported to a standalone, network disconnected environment.

Industry best practices generally call for the separation of HTML from the business logic and database access logic, but the best practices are not strictly enforced. Further, in order to reduce training costs, businesses like to have software applications which work the same no matter where the applications are executed. Since many applications run as web applications, the same look and feel whether running in a network connected environment or in a standalone, network disconnected environment is needed. The standalone, network disconnected environment is commonly known as “offline.” Although an organization may create and maintain the same application twice, once for the enterprise network and once for the offline user, maintaining two separate applications is highly undesirable. To keep software maintenance costs to a minimum, businesses would rather write their applications in such a way as to allow for operation from an enterprise network server or from a standalone, offline computer using the same code.

Several key and often competing concerns in the web application development are productivity, cost and security. The need to make changes and enhancements to any software application but particularly web applications is a constant concern. In a web application development environment these changes may, and often must, be made with turnaround times measured in days or weeks. When the changes involve the use of highly skilled software development personnel, the cost is proportionally higher. The potential for bugs and security leaks are increased with the modification of higher level source code. The fact that system and network security may be compromised by crashing a web application means it is imperative code changes receive a rigorous testing and certification to ensure security is not compromised. The testing and certification further increases cost and delay for the release of a new product. For applications that must be changed faster than the certification process allows, certification becomes an insurmountable problem.

Various embodiments therefore provide the ability for a simple HTML web page using only declarative XML tags to access data services to obtain data from a data storage system that would normally require complex SQL statements or other custom programming and significant knowledge of the data storage system to implement. The declarative XML tags are passed through an abstraction layer that converts the declarative XML tags into the proper format to access the desired data storage system. The complexities of interaction with the data storage system are centralized within the data abstraction layer. The data abstraction layer may be written by a database programming specialist to provide all of the proper data queries needed by a web designer. The web designer is freed from the need to understand the complex syntax and logic necessary to obtain the data from the data storage system. The web page designer does not need to be, or get the assistance of, a specialized database programmer to create a web page. Thus, the implementation of a web page is deskilled to include just the HTML and XML skills necessary to display the data. The web page designer need only declare the look and feel of the page (i.e., what goes where and how it is formatted). A database query expert need only focus on creating queries that produce the appropriate tables of results and nothing more.

Various embodiments also provide the ability to update the user interface without updating the underlying data storage access syntax implemented in the DWA abstraction layer. By eliminating the data storage access syntax from the code of the web page, the web page does not need to be compiled and/or extensively verification tested after minor look and feel changes. Because the changes to the web page do not change Java scripts, or the equivalent, the web page does not need to be compiled. Also, since the declarative XML tags do not contain the data storage request syntax, there is not a need to perform extensive verification testing on the web page.

Further, various embodiments provide the ability for the same web pages to be used to access data from a variety of different data storage systems without making any changes to the web page HTML code. Therefore, the same web pages may be used to retrieve data from a complex relational database found over the Internet as well as on a compressed database stored on a compact disc without any changes to the HTML code. An embodiment simply changes the contents of the query set definition to match the appropriate database or search engine.

Information on the HTML, HTTP and XML specifications are kept by the World Wide Web Consortium (W3C). The W3C is located at MIT, 32 Vassar Street, Room 32-G515, Cambridge, Mass. 02139, telephone number 617-253-2613, and web site http://www.w3.org. Information on the J2EE, JSP and EJB specifications are kept by Sun Microsystems, Inc., 4150 Network Circle, Santa Clara, Calif. 95054, telephone number 800-555-9786, and web site http://java.sun.com.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method of writing and processing an HTML web page comprising:
embedding declarative XML tags within HTML code defining said HTML web page in place of complex data request commands and complex data formatting commands;
converting said declarative XML tags into said complex data request commands for a computer readable data storage system;
sending said complex data request commands to said computer readable data storage system;
receiving raw data from said computer readable data storage system in response to said complex data request commands;
converting said raw data into a dynamic web page based on said declarative XML tags contained within said HTML code; and
delivering said dynamic web page.

2. The method of claim 1 wherein said step of embedding said declarative XML tags within said HTML code in place of said complex data request commands and said complex data formatting commands creates an abstraction layer that eliminates a requirement to utilize a higher level programming language to implement said complex data request commands and said complex data formatting commands.

3. The method of claim 1 wherein said HTML code defining said HTML web page is not compiled.

4. The method of claim 1 wherein said step of converting said declarative XML tags into said complex data request commands for said computer readable data storage system and said step of converting raw data into a dynamic web page based on said declarative XML tags contained within said HTML code does not generate higher level programming language code to include in said HTML code.

5. The method of claim 1 further comprising:
loading said HTML web page into a web browser; and
displaying said dynamic web page on said web browser in response to loading said HTML web page into said web browser.

6. The method of claim 1 wherein said step of converting said declarative XML tags into said complex data request commands for said computer readable data storage system further comprises:
looking up each of said declarative XML tags in a query set definition, said query set definition being a list of possible declarative XML tags, possible data request syntaxes, and correlations between said possible declarative XML tags and said possible data request syntaxes;
associating each of said declarative XML tags with a correlating data request syntax as defined by said query set definition; and
converting each of said declarative XML tags into said complex data request commands based on said correlating data request syntax associated with each of said declarative XML tags.

7. The method of claim 1 wherein said step of converting said raw data into said dynamic web page based on said declarative XML tags contained within said HTML code further comprises:
looking up each of said declarative XML tags in a DWA pages definition, said DWA pages definition being a list of possible declarative XML tags, possible data formats, and correlations between said possible declarative XML tags and said possible data formats;
associating each of said declarative XML tags with a correlating data format as defined by said DWA pages definition; and
converting said raw data into said dynamic web page based on said correlating data request format associated with each of said declarative XML tags converted into said complex data request commands sent to said computer readable data storage system to generate said raw data.

8. The method of claim 1 further comprising making said raw data into name and content addressable data when converting said raw data into said dynamic web page.

9. The method of claim 1 further comprising:
creating a declarative web application abstraction layer within a tag processing container running on a computer system that manages the steps of:
converting said declarative XML tags into said complex data request commands for said computer readable data storage system;
sending said complex data request commands to said computer readable data storage system;
receiving said raw data from said computer readable data storage system in response to said complex data request commands;
converting said raw data into said dynamic web page based on said declarative XML tags contained within said HTML code; and
delivering said dynamic web page.

10. The method of claim 1 wherein said complex data request commands defined by said declarative XML tags are comprised of at least one of the group comprising: data filter, term query, keyword search, key field search, Boolean query, phrase query, prefix query, phrase prefix query range query, filtered query, span query, and fuzzy query.

11. The method of claim 1 wherein in said computer readable data storage system is comprised of at least one of the group comprising: a database, a relational database, a compressed database, a flat file database, an object oriented database, and a remotely accessible search engine.

12. The method of claim 1 wherein said HTML code defining said HTML web page does not need to be updated when said computer readable data storage system is changed to a different computer readable data storage system.

13. A declarative web application abstraction layer running on a computer system for processing an HTML web page comprising:
an HTML web page input for receiving said HTML web page from a web browser application, said HTML web page defined by HTML code containing embedded declarative XML tags in place of complex data request commands and complex data formatting commands;
a data request command output for sending said complex data request commands to a computer readable data storage system;
a raw data input for receiving raw data from said computer readable data storage system in response to said complex data request commands;
a dynamic web page output for delivering a dynamic web page to said web browser application;
a DWA query generation engine that converts said declarative XML tags contained in said HTML web page received by said HTML web page input into said complex data request commands and that further sends said complex data request commands to said computer readable storage system via said data request command output;
a DWA result formatting engine that converts said raw data received by said raw data input in response to said complex data request commands sent to said computer readable storage system into said dynamic web page based on said declarative XML tags contained within said HTML code and that further sends said dynamic web page to said web browser via said dynamic web page output.

14. The declarative web application abstraction layer of claim 13 wherein said embedded declarative XML tags in said HTML code defining said HTML web page eliminate a requirement to utilize a higher level programming language to implement said complex data request commands and said complex data formatting commands in said HTML code.

15. The declarative web application abstraction layer of claim 13 wherein said HTML code defining said HTML web page is not compiled.

16. The declarative web application abstraction layer of claim 13 wherein said DWA query generation engine and said DWA result formatting engine do not generate higher level programming language code to include in said HTML code.

17. The declarative web application abstraction layer of claim 13 further comprising:
a query set definition that lists possible declarative XML tags, possible data request syntaxes, and correlations between said possible declarative XML tags and said possible data request syntaxes; and
wherein said DWA query generation engine associates each of said declarative XML tags with a correlating data request syntax as defined by said query set definition, and said DWA query generation engine further converts each of said declarative XML tags into said complex data request commands based on said correlating data request syntax associated with each of said declarative XML tags.

18. The declarative web application abstraction layer of claim 13 further comprising:
a DWA pages definition that lists possible declarative XML tags, possible data formats, and correlations between said possible declarative XML tags and said possible data formats; and
wherein said DWA result formatting engine associates each of said declarative XML tags with a correlating data format as defined by said DWA pages definition, and said DWA result formatting engine further converts said raw data into said dynamic web page based on said correlating data request format associated with each of said declarative XML tags converted into said complex data request commands sent to said computer readable data storage system to generate said raw data.

19. The declarative web application abstraction layer of claim 13 wherein said DWA result formatting engine makes said raw data into name and content addressable data when converting said raw data into said dynamic web page.

20. The declarative web application abstraction layer of claim 13 wherein said declarative web application abstraction layer is contained within a tag processing container.

21. The declarative web application abstraction layer of claim 13 wherein said complex data request commands defined by said declarative XML tags are comprised of at least one of the group comprising: data filter, term query, keyword search, key field search, Boolean query, phrase query, prefix query, phrase prefix query range query, filtered query, span query, and fuzzy query.

22. The declarative web application abstraction layer of claim 13 wherein in said computer readable data storage system is comprised of at least one of the group comprising: a database, a relational database, a compressed database, a flat file database, an object oriented database, and a remotely accessible search engine.

23. The declarative web application abstraction layer of claim 13 wherein said HTML code defining said HTML web page does not need to be updated when said computer readable data storage system is changed to a different computer readable data storage system.

24. A declarative web application abstraction layer running on a computer system for processing an HTML web page comprising:
means for obtaining an HTML web page defined by HTML code with embedded declarative XML tags in place of complex data request commands and complex data formatting commands;
means for converting said declarative XML tags into said complex data request commands;
means for sending said complex data request commands to a computer readable data storage system;
means for receiving raw data from said computer readable data storage system in response to said complex data request commands;
means for converting said raw data into a dynamic web page based on said declarative XML tags contained within said HTML code; and
means for delivering said dynamic web page.
